(19) United States
(12) Patent Application Publication
(10) Pub. No.: US 2025/0289219 A1
(43) Pub. Date: Sep. 18, 2025

(54) LIQUID EJECTION HEAD AND LIQUID EJECTION METHOD

(71) Applicant: CANON KABUSHIKI KAISHA, Tokyo (JP)

(72) Inventors: TAKASHI KATO, Kanagawa (JP); YOSHIYUKI NAKAGAWA, Kanagawa (JP); TOSHIO NEGISHI, Kanagawa (JP)

(21) Appl. No.: 19/078,083

(22) Filed: Mar. 12, 2025

(30) Foreign Application Priority Data
Mar. 14, 2024 (JP) 2024-040044
Dec. 23, 2024 (JP) 2024-226777

(51) Int. Cl. B41J 2/045; B41J 2/14

(52) U.S. Cl. CPC B41J 2/0455; B41J 2/04541; B41J 2/0458; B41J 2/14145

(57) ABSTRACT

A liquid ejection method uses: a separate ejection unit including an ejection orifice, a pressure chamber, a first heat energy generating element provided for the pressure chamber, a separate flow path communicating with the pressure chamber, and a second heat energy generating element provided for the separate flow path; and a liquid ejection head including a common flow path for supplying a liquid to the plural separate flow paths of the plural separate ejection units. In drive control of the first heat energy generating element and the second heat energy generating element, when the first heat energy generating element is driven, the second heat energy generating element is not driven, and, when the first heat energy generating element is not driven, the second heat energy generating element is driven upon receiving a driving signal that instructs drive relative to the second heat energy generating element.

### BACKGROUND OF THE INVENTION

### Field of the Invention

The present invention relates to a liquid ejection head and a liquid ejection method using the liquid ejection head.

### Description of the Related Art

There is known a circulation type liquid ejection device that circulates an ink for expelling a bubble in a flow path and suppressing the ink in the vicinity of an ejection orifice from being thickened in a liquid ejection head (hereinafter, also referred to as “head”). As a method for circulating the ink, a system using pressure difference (hereinafter, also referred to as “differential pressure system”) is well known. In this system, with a pressure adjustment mechanism or the like, the pressure on a side (IN side) on which the ink is supplied to the ejection orifice is made higher than the pressure on a side (OUT side) on which the ink is collected, thereby causing the ink to flow in from the IN side toward the OUT side. At this point, in order to circulate the ink, the ink that has flowed to the OUT side needs to be returned to the IN side, and a pump as a mechanism for such returning is thus required. Note that, in some configurations, by providing the pump outside the head of, for example, a printing apparatus main body, a liquid is circulated between the liquid ejection head and the main body, while in other configurations, by providing the pump inside the liquid ejection head, a liquid is circulated inside the liquid ejection head. However, such circulating methods of the differential pressure system require the pressure adjustment mechanism and a mechanism such as the pump, and the printing apparatus main body and the head are likely to be upsized.

Thus, ink circulation methods other than the differential pressure system are considered. Specifically, there is known a mechanism in which a circulatory flow path communicating with an ejection orifice is provided, and an energy generating element (hereinafter, also referred to as “flow energy generating element”) that is different from an energy generating element (hereinafter, also referred to as “ejection energy generating element”) configured to eject the ink is disposed in the circulatory flow path. In the mechanism, the ink is circulated in the circulation path by driving the flow energy generating element.

Japanese Patent Laid-Open No. 2020-104312 discloses a configuration in which a circulatory flow path extending so as to intersect an ejection orifice array including plural arranged ejection orifices is provided, and the circulatory flow path includes a flow energy generating element.

### SUMMARY OF THE INVENTION

The present invention provides a liquid ejection method using: a separate ejection unit including, an ejection orifice through which a liquid is ejected, a pressure chamber communicating with the ejection orifice, a first heat energy generating element provided for the pressure chamber and configured to generate heat energy for ejecting a liquid from the ejection orifice, a separate flow path communicating with the pressure chamber, and a second heat energy generating element provided for the separate flow path; and a liquid ejection head including a common flow path for supplying a liquid to a plurality of the separate flow paths of a plurality of the separate ejection units, in which the first heat energy generating element and the second heat energy generating element are controlled to be driven under a condition that, when the first heat energy generating element is driven, the second heat energy generating element is not driven, and, when the first heat energy generating element is not driven, the second heat energy generating element is driven upon receiving a driving signal that instructs drive relative to the second heat energy generating element.

The present invention provides a liquid ejection head including, an ejection orifice through which a liquid is ejected, a pressure chamber communicating with the ejection orifice, a first heat energy generating element provided for the pressure chamber and configured to generate heat energy for ejecting a liquid from the ejection orifice, a separate flow path communicating with the pressure chamber, a second heat energy generating element provided for the separate flow path, and a driving circuit configured to control drive of the first heat energy generating element and the second heat energy generating element, in which the driving circuit includes a first switch capable of switching the first heat energy generating element and the second heat energy generating element mutually exclusively so as to bring only any of the first heat energy generating element and the second heat energy generating element into a drivable state and a second switch capable of switching, in the second heat energy generating element, between the drivable state and a driving disabled state.

Further features of the present invention will become apparent from the following description of exemplary embodiments with reference to the attached drawings.

### BRIEF DESCRIPTION OF THE DRAWINGS

FIGS. 1A and 1B are each an entire view of a device utilizing a liquid ejection head.

FIGS. 2A to 2D are an entire view of the liquid ejection head and entire views of liquid ejection chips.

FIGS. 3A to 3D are each a schematic view of the vicinity of an ejection orifice of a liquid ejection head.

FIGS. 4A to 4C are each a schematic view of the vicinity of the ejection orifice of the liquid ejection head.

FIGS. 5A to 5D are each a schematic view of the vicinity of the ejection orifice of the liquid ejection head.

FIGS. 6A to 6D are each a schematic view of the vicinity of an ejection orifice of a liquid ejection head.

FIGS. 7A to 7C are each a schematic view of the vicinity of an ejection orifice of a liquid ejection head in a first embodiment.

FIG. 8 is a circuit configuration diagram in a comparative configuration.

FIG. 9 is a circuit configuration diagram in the first embodiment.

FIGS. 10A to 10C are each a schematic view of the vicinity of an ejection orifice of a liquid ejection head in a second embodiment.

FIGS. 11A to 11C are each a schematic view of the vicinity of an ejection orifice of a liquid ejection head in a third embodiment.

FIGS. 12A and 12B are each a schematic view of the vicinity of an ejection orifice of a liquid ejection head in a fourth embodiment.

FIGS. 13A and 13B are each a schematic view of the vicinity of an ejection orifice of a liquid ejection head in a fifth embodiment.

FIGS. 14A to 14C are each a schematic view of the vicinity of an ejection orifice of a liquid ejection head in a sixth embodiment.

FIGS. 15A to 15C each illustrate the timing of drive to energy generating elements in the first embodiment.

### DESCRIPTION OF THE EMBODIMENTS

However, Japanese Patent Laid-Open No. 2020-104312 has yet to describe what driving data is used to drive the ejection energy generating element and the flow energy generating element that are each an electrothermal conversion element. In general, providing driving data for each of the energy generating elements can be considered, but the data amount is increased according to the number of the energy generating elements. Accordingly, the present invention provides a liquid ejection head and a liquid ejection device capable of driving with optimized data amount, in an ink circulating system as in Japanese Patent Laid-Open No. 2020-104312 using an ejection energy generating element and a flow energy generating element in combination.

Hereinafter, embodiments of the present disclosure will be described in detail with reference to the attached drawings. Note that the following embodiments are not intended to limit the content of the present disclosure, and not all combinations of the features described in the present embodiments are essential to the solution of the present disclosure. Note that the same constituent elements are denoted by the same reference numbers. In the following description, the basic configuration of the present disclosure is described first, and features of the present disclosure are then described.

### Liquid Ejection Device

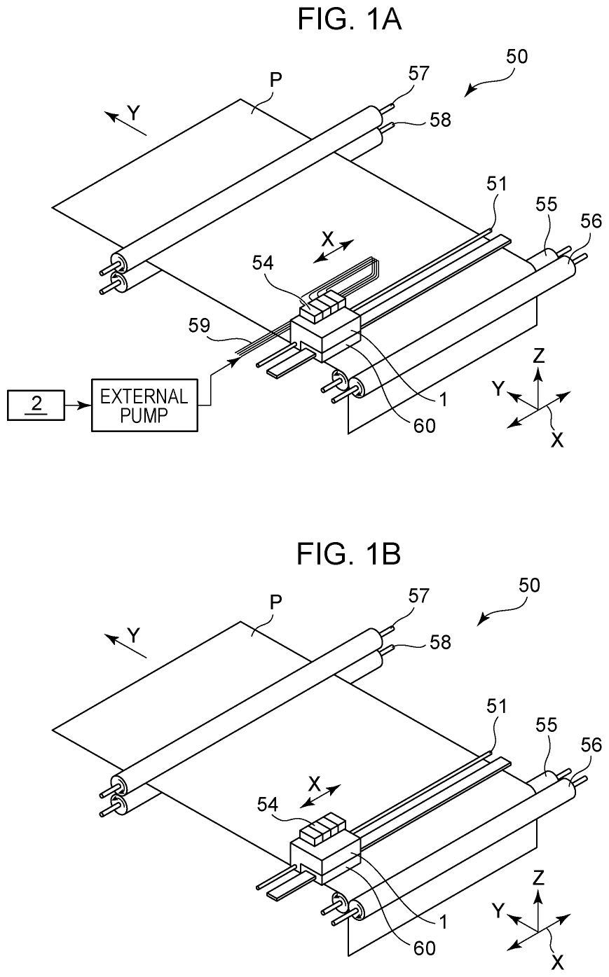

First, the outline configuration of a liquid ejection device 50 in the present embodiments will be described. FIGS. 1A and 1B are each an enlarged view of a liquid ejection head 1 of the liquid ejection device 50 and a region therearound and are each a perspective view schematically illustrating the liquid ejection device using the liquid ejection head. The liquid ejection device 50 illustrated in FIGS. 1A and 1B is a liquid ejection device (of serial type) that prints an image by ejecting a liquid onto a printing medium P by using the liquid ejection head that scans in a direction intersecting a conveyance direction of the printing medium P. The present invention is applicable to not only the serial type liquid ejection device but also a page wide type liquid ejection device that prints an image on the printing medium conveyed in the conveyance direction by ejecting a liquid by using a line head (page wide type head) made long in a page width direction of the printing medium. Note that the liquid ejection head in the present embodiments is capable of ejecting inks of four types: black (K), cyan (C), magenta (M), and yellow (Y) and capable of printing a full-color image with the inks. The inks that can be ejected from the liquid ejection head are not limited to the above-described inks of four types. The present disclosure is also applicable to a liquid ejection head configured to eject another type of ink. That is, the ink type and the number of inks ejected from the liquid ejection head are not limited.

In the serial type liquid ejection device 50, the liquid ejection head 1 is mounted on a carriage 60. The carriage 60 moves reciprocally in a main scanning direction (X direction) along a guide shaft 51. The printing medium is conveyed in a sub-scanning direction (Y direction) intersecting (in the present embodiments, orthogonal to) the main scanning direction, by conveyance rollers (convey units) 55, 56, 57, and 58. Note that, in each figure referred to below, the Z direction indicates the vertical direction and intersects (in the present embodiments, orthogonal to) the X-Y plane defined by the X direction and the Y direction.

FIG. 1A illustrates a configuration in which a main ink tank 2 serving as a liquid reservoir is provided outside the liquid ejection head. The liquid (ink) stored in the ink tank 2 is supplied to a sub-ink tank 54 on the liquid ejection head 1 side through, for example, an ink supply tube (liquid communication path) 59 by the driving force of an external pump. On the other hand, FIG. 1B illustrates a configuration in which the ink tank 54 is provided immediately above the liquid ejection head 1 (no main ink tank 2 serving as the liquid reservoir is provided outside the liquid ejection head). At this point, in some cases, the liquid ejection head 1 is integrally provided with the ink tank 54 and is detachable/attachable relative to the carriage 60, while in other cases, the liquid ejection head 1 is integrally provided with the carriage 60, and only the ink tank 54 is detachable/attachable. Hereinafter, description is made while using the configuration in FIG. 1A as a representative example.

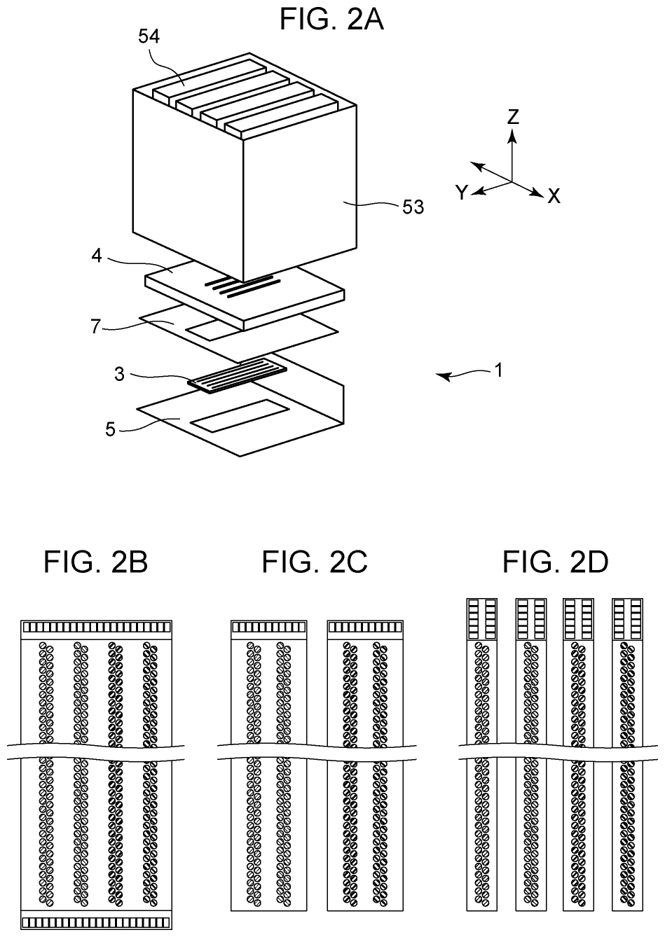

The liquid ejection head 1 includes a separate ejection unit described later (refer to FIGS. 2A to 2D).

Although a specific configuration will be described later, the separate ejection unit includes an ejection orifice through which a liquid is ejected, a pressure chamber communicating with the ejection orifice, a first energy generating element (ejection energy generating element) provided for the pressure chamber and configured to generate energy for ejecting a liquid through the ejection orifice, a separate flow path communicating with the pressure chamber, and a second energy generating element (flow energy generating element) provided for the separate flow path. The liquid ejection head 1 includes plural separate ejection units and includes a supply flow path for supplying a liquid to the separate flow paths in the respective separate ejection units.

In using the liquid ejection head, ejection of a liquid may become unstable due to, for example, evaporation of a volatile component such as water from the ejection orifice and solid content condensation near the ejection orifice with the evaporation, and various contrivances have been made to prevent such evaporation and condensation. For example, there can also be provided in the liquid ejection device, at a position off a conveyance path of the printing medium in the X direction, a cap member (not illustrated) capable of covering an ejection orifice surface in which the ejection orifice of the liquid ejection head is formed. The cap member is used for the purpose of prevention of drying of the ejection orifice and protection of the ejection orifice by covering the ejection orifice surface of the liquid ejection head, for example, when a printing operation is not performed. An ink suction mechanism (not illustrated) can further be provided, and, in that case, the cap member is used for an operation of sucking the ink from the ejection orifice or other operations. By performing such an ink sucking operation, the ink near the ejection orifice is refreshed, and the quality of an obtainable image can be maintained. There are also known a method in which the concentrated ink is discarded by performing ejection referred to as preliminary ejection when no printing operation is performed and a method in which, even during the printing operation, the ink is preliminarily ejected (preliminary ejection onto paper surface/in-page preliminary ejection) with such an amount and onto such a spot on the printing medium that the ejected ink is inconspicuous in terms of image quality. The above methods make a significant contribution to improvement in image quality, but the amount of waste ink needs to be minimized because a portion of the ink will be discarded for refreshing the ejection orifice.

For such a challenge, drying of the ejection orifice and condensation of the ink occurring near the ejection orifice can be suppressed while the amount of waste ink is suppressed from increasing, by providing the second energy generating element (flow energy generating element) in the separate flow path and by circulating the ink inside the flow path. More specifically, the number of times of preliminary ejection and suction recovery can be minimized. Moreover, when the number of times of, for example, preliminary ejection can be minimized, throughput and yield can be improved.

The second energy generating element (flow energy generating element) is not necessarily provided in every separate ejection unit of the liquid ejection head. Provision of the second energy generating elements (flow energy generating elements) even for some of the separate ejection units can produce the above-described effects, compared with the case without the second energy generating element.

The liquid ejection head illustrated in FIG. 1A may have a configuration in which all spots corresponding to the four types of inks are provided with the second energy generating elements or may have a configuration in which only a spot corresponding to one type of ink is provided with the second energy generating element. That is, the liquid ejection head may be configured to circulate at least only one type of ink, not all the four types of inks.

### Basic Configuration of Liquid Ejection Head

FIG. 2A is an exploded perspective view of the liquid ejection head according to the present embodiments. As FIGS. 2A to 2D illustrate, the liquid ejection head includes the sub-ink tank 54 allowing the ink to be stored temporarily in the head and a liquid ejection chip 3 for ejecting the ink supplied from the sub-ink tank 54, onto the printing medium P. The liquid ejection head in the present embodiments is fixed to and supported by the carriage of the liquid ejection device by using a positioning unit and an electrical contact (not illustrated) provided in the carriage. The liquid ejection head performs printing on the printing medium P by ejecting the ink while moving with the carriage in the main scanning direction (X direction) illustrated in FIG. 1A.

The ink supply tube 59 is provided for the external pump connected to the ink tank 2 serving as a supply source of the ink (refer to FIG. 1A). A liquid connector (not illustrated) is provided on a distal end of the ink supply tube. When the liquid ejection head 1 is mounted on the liquid ejection device 50, the liquid connector provided on the distal end of the ink supply tube 59 is liquid-tightly connected to a liquid connector insertion slot provided in a head housing of the liquid ejection head 1 and serving as an introduction port of a liquid.

Thus, an ink supply path from the ink tank 2, through the external pump, to the liquid ejection head 1 is formed. In the present embodiments, since the four types of inks are used, four sets of the ink tank 2, the external pump, the ink supply tube 59, and the sub-ink tank 54 are provided while corresponding to the respective inks, and four ink supply paths corresponding to the respective inks are formed independently. As described above, the liquid ejection device according to the present embodiments is provided with an ink supply system by which the inks are supplied from the ink tanks 2 provided outside the liquid ejection head 1. Note that the liquid ejection device according to the present embodiments is not provided with any ink collection system that collects the ink inside the liquid ejection head into the ink tank. Thus, the liquid ejection head has the liquid connector insertion slot for connection of the ink supply tube of the ink tank but has no connector insertion slot for connection of a tube for collecting the ink in the liquid ejection head into the ink tank. Note that the liquid connector insertion slot is provided for each ink.

FIGS. 2B to 2D are each an entire view of the liquid ejection chip constituting the liquid ejection head. FIG. 2B illustrates a configuration in which one chip is provided per four colors, FIG. 2C illustrates a configuration in which one chip is provided per two colors, and FIG. 2D illustrates a configuration in which one chip is provided per one color. Each of the liquid ejection chips includes ejection orifices and a pad used for electrical mounting. In FIG. 2A, the chip configuration of FIG. 2B is given.

FIG. 2B illustrates a first configuration example in which one chip is configured per four colors. The four colors are, for example, black, cyan, magenta, and yellow, and arrays are formed with the respective colors and arranged in the Y direction. The ejection orifices in every adjacent arrays are misaligned in the X direction and are spaced uniformly along the Y direction. Here, the ejection orifices in the adjacent arrays may be arranged in one array along the Y direction without being misaligned in the X direction. In addition, two arrays may be provided only for black, and five arrays in total may be provided for four colors.

FIG. 2C illustrates a second configuration example using two chips each configured per two colors.

When such two chips are mounted in the liquid ejection head, the two chips may be mounted in one liquid ejection head, or two heads each including one chip may be prepared.

FIG. 2D illustrates a third configuration example using four chips each configured per one color. As with FIG. 2C, such four chips may be mounted in one liquid ejection head, or four heads each including one chip may be prepared.

In the case of divided plural chips as in FIGS. 2C and 2D, not all the chips need to have the same chip length. In addition, various other combinations of the number of colors relative to the chip are possible, and the same applies to a case where the total number of colors is more than four.

### Constituent Elements of Circulation Unit

### Straight Type

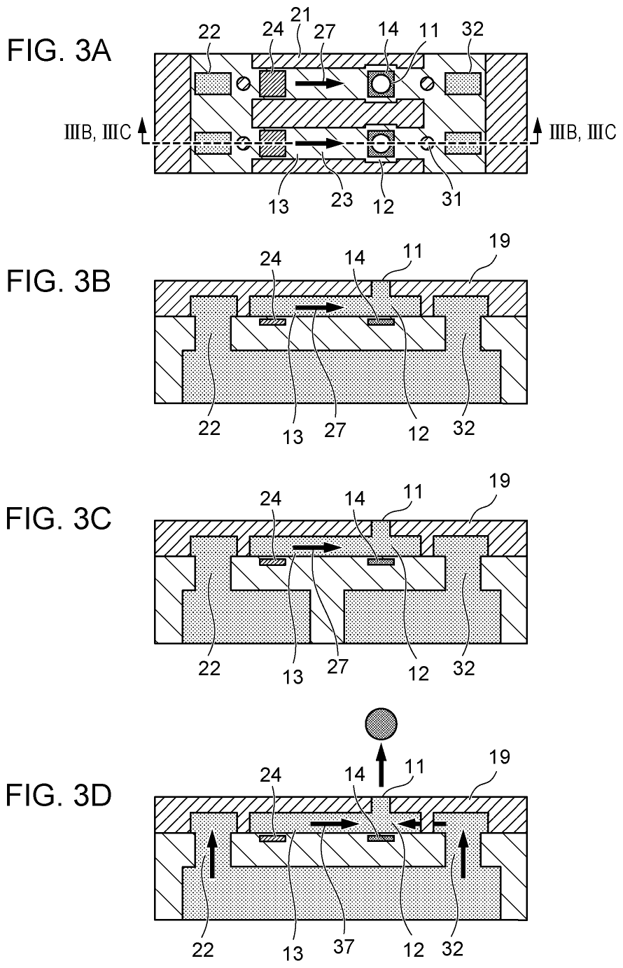

FIGS. 3A to 3D are each a schematic view for illustrating the vicinity of an ejection orifice of a liquid ejection head of straight type.

The “straight type” herein refers to a type in which a separate flow path where a first energy generating element (ejection energy generating element) and a second energy generating element (flow energy generating element) are disposed has a straight shape extending in a direction intersecting (in the case of FIGS. 3A to 3D, orthogonal to) an ejection orifice array such that both end portions of the separate flow path are positioned on both sides across the ejection orifice array. In other words, in the separate flow path of a separate ejection unit, the first energy generating element and the second energy generating element are arranged in the direction intersecting the ejection orifice array.

FIG. 3A is a plan view when viewed from the side to which a droplet is ejected from the ejection orifice. FIG. 3B is a sectional view taken along line IIIB-IIIB in FIG. 3A. FIG. 3C is another sectional view taken along line IIIC-IIIC in FIG. 3A. FIG. 3D illustrates the inflow of the ink when the first energy generating element is driven.

In FIGS. 3A to 3C, there are formed, between a substrate 18 and an orifice plate 19, a pressure chamber 12 partitioned by partitions 21 and corresponding to each ejection orifice 11 and a separate flow path 23 for causing the ink to flow while passing through the corresponding pressure chamber 12. A meniscus of the ink is formed in each of the ejection orifices 11 as an ejection-port interface that is the interface between the ink and the atmosphere.

The substrate 18 is provided with a first energy generating element 14 that is an electrothermal conversion element configured to generate energy for ejecting the ink inside the pressure chamber. The first energy generating element 14, along with the ejection orifice 11 and the pressure chamber 12, is positioned closer to a second supply opening 32 than to a first supply opening 22. The first energy generating element 14 is driven to generate heat and generates a bubble in the ink inside the pressure chamber 12, and the ink can thereby be ejected from the ejection orifice 11 by utilizing such bubble generating energy.

The substrate 18 is further provided with a second energy generating element 24 that is an electrothermal conversion element configured to generate energy for generating a circulatory flow 27 of the ink, inside the separate flow path, indicated by the arrow.

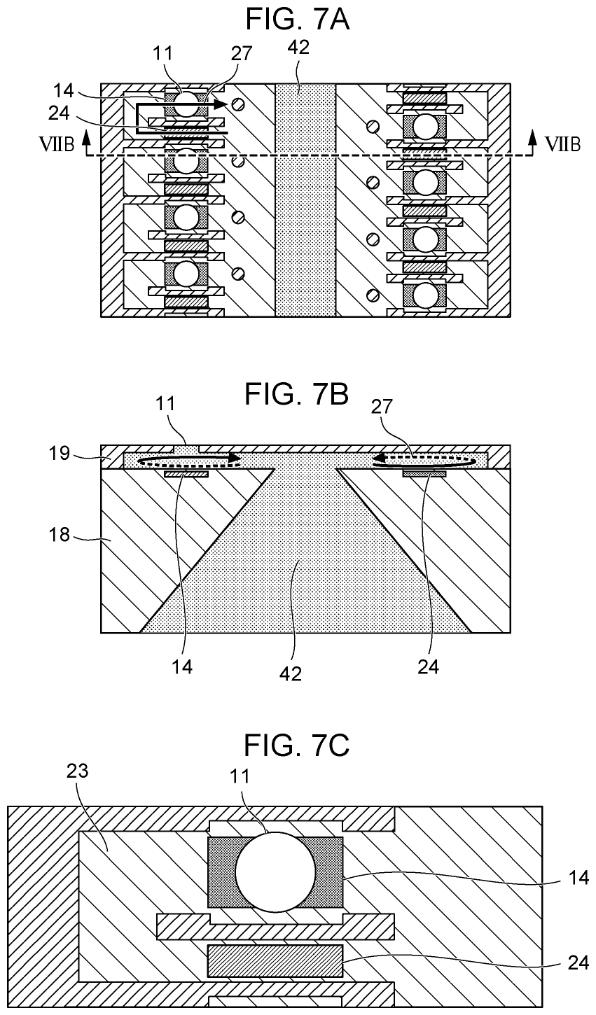

Moreover, the substrate 18 has an opening through which a liquid is supplied from a common flow path to the separate flow paths. As for such an opening, plural openings (independent supply openings) may be provided as in FIG. 3A or a supply groove formed as one large opening may be provided as in FIG. 7A referred to later. The second energy generating element 24 is positioned closer to the first supply opening 22 than to the second supply opening 32.

The separate flow path 23 extends in a second direction intersecting (in the present embodiments, orthogonal to) a direction (first direction) where the ejection orifices are arranged in an array. The separate flow path 23 includes the pressure chamber 12, a connection flow path 13 communicating with an end portion on one side of the pressure chamber 12 and positioned on the inlet port side (upstream) in FIG. 3B, and a flow path communicating with an end portion on the other side of the pressure chamber 12 and positioned on the outlet port side (downstream) in the FIG. 3B. The separate flow path 23, at one end on the upstream side and the other end on the downstream side, communicates with the first supply opening 22 and the second supply opening 32 that each pass through the substrate 18. Thus, the connection flow path 13 is positioned closer to the second energy generating element than the ejection orifice array. Both end portions of the separate flow path 23 are positioned on opposite sides across the ejection orifice array.

The ink flows moving in the separate flow path are roughly divided into two: (1) a first ink flow for refilling after the ejection performed by driving the first energy generating element 14, and (2) a second ink flow for forming a circulatory flow generated by driving the second energy generating element 24.

When the first energy generating element 14 is driven to eject a liquid from the ejection orifice 11, in order to supply the ink associated with the ejection from the first supply opening 22 and the second supply opening 32 as illustrated in FIG. 3D, the ink is caused to flow into the pressure chamber from both the supply openings.

When the second energy generating element 24 is driven to form a circulatory flow, relative to the separate flow path 23, the ink flows in through the first supply opening 22 that is the connection flow path side and flows out through the second supply opening 32 that is not the connection flow path side. In the present embodiments, the ink flowing out from the second supply opening 32 is circulated by being returned in the first supply opening 22, thereby forming the circulatory flow 27, indicated by the arrow, inside the separate flow path 23. Note that a configuration in which the first supply opening 22 and the second supply opening 32 are commonized inside the chip is illustrated in FIG. 3B. In addition, a configuration in which the first supply opening 22 and the second supply opening 32 are connected to the separate flow path and are commonized outside the printing head is illustrated in FIG. 3C, and any of the configurations may be used.

A filter 31 that removes foreign substances in the ink may be provided in circulatory flow paths of the ink inside and outside a printing head. In FIGS. 3A to 3D, the filter is disposed on each of the inflow side and the outflow side that are the outer sides of the separate flow path. In addition, a filter may be disposed, in the separate flow path, between the first energy generating element and the second energy generating element. In such a case, the filter is not necessarily disposed on the upstream side (the second energy generating element side) that is the outer side of the separate flow path.

### U-Shape Type

The vicinity of an ejection orifice of a liquid ejection head of U-shape type will be described with FIGS. 7A to 7C of a first embodiment described later herein. The “U-shape type” refers to a configuration including a U-shaped flow path where a first energy generating element (ejection energy generating element) and a second energy generating element (flow energy generating element) are disposed. That is, in a separate flow path, the first energy generating element and the second energy generating element are disposed along an ejection orifice array.

In the separate flow path, both end portions thereof are positioned on one side relative to the ejection orifice array. FIG. 7A is a plan view when viewed from the side to which a droplet is ejected from the ejection orifice. FIG. 7B is a sectional view taken along line VIIB-VIIB in FIG. 7A. FIG. 7C is a schematic enlarged view illustrating element names in a separate flow path portion in FIG. 7A.

In FIGS. 7A to 7C, a first energy generating element 14 and a second energy generating element 24 are both positioned near a supply groove 42. The first energy generating element and the second energy generating element are arranged alternately in a direction (first direction) in which the ejection orifices are arranged in an array, and a separate flow path 23 is formed into a bent shape (U shape) so as to connect the energy generating elements. The separate flow path 23 includes a pressure chamber 12, a connection flow path 13 communicating with an end portion on one side of the pressure chamber 12 and positioned on the inlet port side (upstream) in FIG. 7B, and a flow path communicating with an end portion on the other side of the pressure chamber 12 and positioned on the outlet port side (downstream) in the FIG. 7B. The separate flow path 23, on both the upstream side and the downstream side thereof, communicates with the supply groove 42 passing through a substrate 18. Both the end portions of the separate flow path 23 are positioned adjacent to each other on one side of the supply groove 42.

As with the straight type, the ink flows moving in the separate flow path are divided into two: (1) a first ink flow, and (2) a second ink flow.

When the first energy generating element 14 is driven to eject a liquid from the ejection orifice 11, in order to supply the ink associated with the ejection from the supply groove 42, the ink is caused to flow into the pressure chamber from both the connection flow path side and the opposite side.

When the second energy generating element 24 is driven to form a circulatory flow, relative to the separate flow path 23, the ink flows in from the inlet port side (upstream) that is the connection flow path side and flows out to the outlet port side (downstream). In the present embodiment, due to inflow to and outflow from the common supply groove 42 on both the sides, a circulatory flow 27 indicated by the arrow is formed inside the separate flow path 23. Note that the supply groove 42 is given in the present embodiment but may be replaced with a supply opening array arranged in the first direction as illustrated in FIGS. 3A to 3D. When the supply openings replace, the supply openings are commonized inside the chip as with FIG. 3B.

### Pump Principle

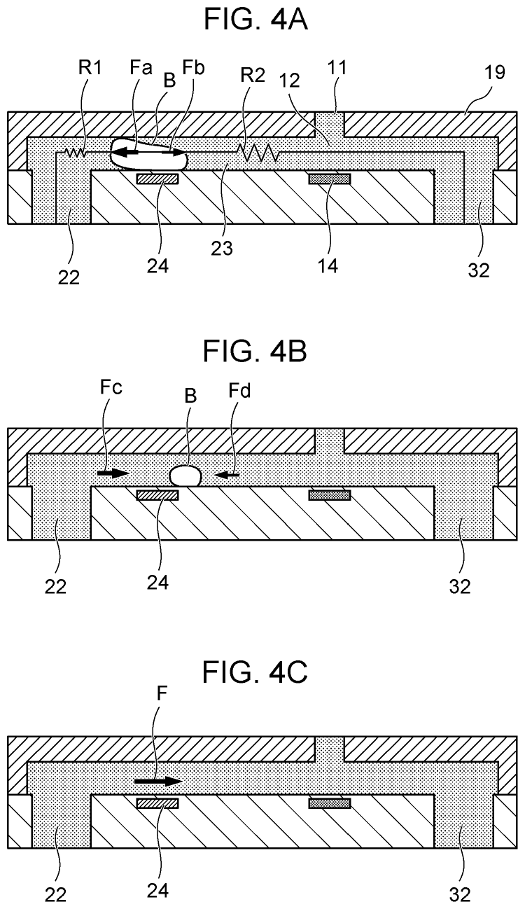

FIGS. 4A to 4C are each a diagram for illustrating the principle of generation of a circulatory flow of the ink when the second energy generating element (circulatory heater) 24 that is an electrothermal conversion element is used. FIGS. 4A to 4C are sectional views, as with FIG. 3B, illustrating, when the ink is film-boiled by being heated by the circulatory heater 24 and generates a bubble B, a generation and growth process, a shrinkage process, and a post-bubble disappearance process, respectively. In FIG. 4A, the circulatory heater 24 is positioned closer to the first supply opening 22 than to the second supply opening 32. Thus, a flow resistance R1 between the circulatory heater 24 and the first supply opening 22 is smaller than a flow resistance R2 between the circulatory heater 24 and the second supply opening 32. FIG. 4A is combined with an equivalent circuit in which the above flow resistances R1 and R2 are each represented as electric resistance. The bubble B generated by the film boiling of the ink grows toward the first supply opening 22 side with the smaller flow resistance R1, as in FIG. 4A, due to the difference between the flow resistances R1 and R2. Thus, inside the separate flow path 23, a flow Fa of the ink toward the first supply opening 22 is larger than a flow Fb of the ink toward the second supply opening 32.

FIG. 4B illustrates ink flows in the shrinkage process of the bubble B. In the shrinkage process of the bubble B, the ink flows in so as to compensate for the volume of the shrinkage. In such a case, as with FIG. 4B, a flow Fc of the ink flowing in from the first supply opening 22 on the small flow resistance R1 side is larger than a flow Fd of the ink flowing in from the second supply opening 32 on the large flow resistance R2 side.

In addition, the position at which the bubble B disappears is shifted closer to the second supply opening 32 from a spot above the circulatory heater 24.

FIG. 4C illustrates the post-bubble disappearance process of the bubble B. Due to the relationship Fc>Fd generated in FIG. 4B, a circulatory flow F of the ink from the first supply opening 22 toward the second supply opening 32 is generated.

The magnitude of such a circulatory flow F is affected by the ratio of the flow resistances R1 and R2 and the size of the bubble B. For example, on the assumption that the circulatory heater 24 that is an electrothermal conversion element is used as the second energy generating element 24, the second energy generating element 24, in particular, can be positioned closer to either of both the end portions of the separate flow path 23 than the first energy generating element. More specifically, the flow resistance ratio R1/R2 can be set in the range of 0.05 to 0.40. By setting the flow resistance ratio R1/R2 in the above range, the circulatory flow F can be set to a maximum value. For the circulatory flow F, it is important to increase the magnitude of the flow Fa of the ink toward the supply flow path 14 illustrated in FIGS. 4A and 4B and to increase the flow Fc of the ink flowing in from the first supply opening 22. Thus, reducing the flow resistance R1 is effective. It is also important to reduce the flow Fd of the ink flowing in from the second supply opening 32 by minimizing the flow Fb of the ink toward the outflow path 15. Thus, increasing the flow resistance R2 is effective. From the above, it is important to reduce the flow resistance R1 and to increase the flow resistance R2, that is, to reduce the flow resistance ratio R1/R2. In addition, a large bubble B, that is, a large bubble volume leads to increase in excluded volume of the fluid generated in the separate flow path 23, thereby increasing the magnitude of the circulatory flow F. Examples of a way of increasing the bubble volume include:
Size increase of the circulatory heater 24
Reduction in flow resistance by increasing the width and/or height, on the inner side, of the flow path 13
Reduction in ink viscosity
Increase in head temperature
Double pulsing of driving pulse

With the entry of a portion of the circulatory flow F of the ink into the ejection orifice 11, the concentrated ink inside the ejection orifice 11 is sent to the second supply opening 32 side, and the fresh ink is thus caused to flow into the ejection orifice 11 from the first supply opening 22 side through the connection flow path 13. As described above, by making it difficult for the concentrated ink to stagnate inside the ejection orifice 11, the effect of the concentrated ink is suppressed, and an initial ink ejection state can be maintained.

The circulatory flow F is a transitional flow associated with the growth process and the shrinkage process when the bubble B is generated.

Thus, after the bubble B disappears, an inertial flow attenuates over time and stops after a predetermined time period. Accordingly, a heating element of the circulatory heater 24 needs to be driven repeatedly in order to generate the circulatory flow F steadily for a certain time period. The driving cycle of the circulatory heater 24 is not particularly limited as long as the concentrated ink inside the ejection orifice 11 can be discharged. However, due to the transitional flow associated with the growth process and the shrinkage process when the bubble B is generated, the effect is reduced when driving at a high drive frequency such as 100 kHz in consideration of a cycle of 10 us that is the time from the generation to the disappearance of the bubble. Thus, for example, the circulatory heater 17 can be driven at a cycle of about 100 Hz to several tens of kHz, and the discharge effect of the concentrated ink is increased since the circulatory flow F is maintained as the drive frequency increases. However, on the other hand, increase in the temperature of the ink caused by heat generation by drive of the circulatory heater 24 needs to be considered. Thus, the circulatory heater 24 needs to be driven at the appropriate number of times of driving.

### Recirculatory Concentration

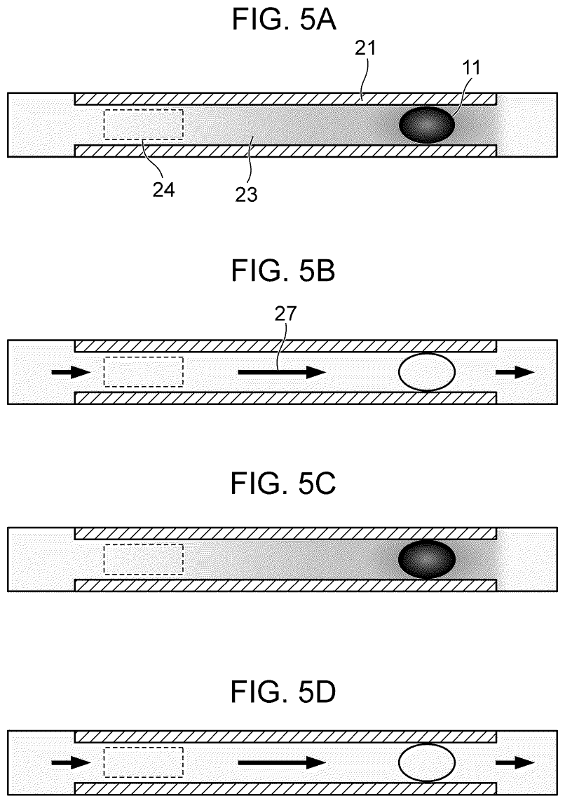

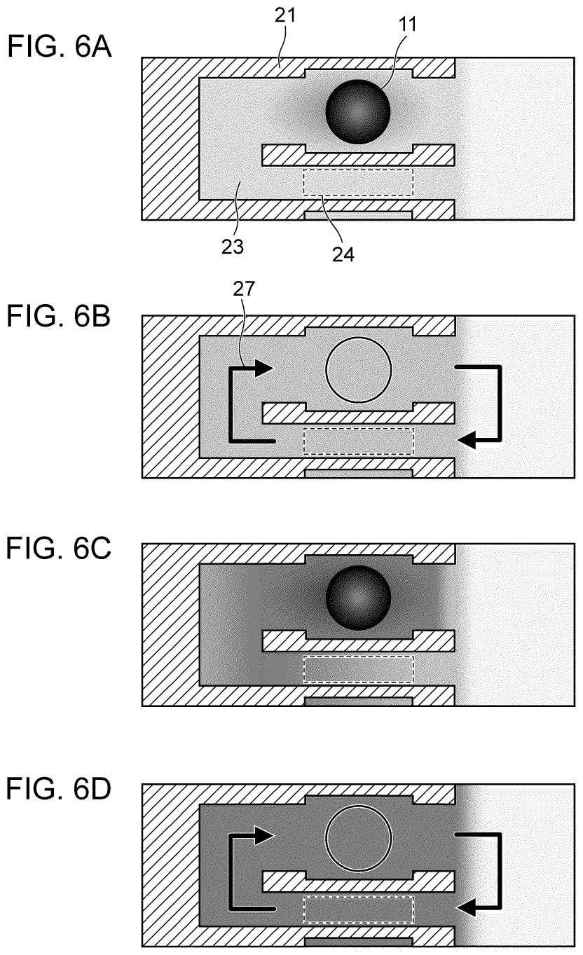

FIGS. 5A to 5D and 6A to 6D are each a diagram for illustrating how concentration is eliminated with the circulatory flow of the ink generated by the second energy generating element. FIGS. 5A to 5D illustrate the configuration of the straight type in which the inlet port and the outlet port for the circulatory flow in the separate flow path are separated from each other, and FIGS. 6A to 6D illustrate the configuration of the U-shape type in which the inlet port and the outlet port for the circulatory flow in the separate flow path are adjacent. Note that a spot where the ink is concentrated is indicated by dark color, and the degree of concentration is represented by the shade of color.

First, in FIGS. 5A to 5D, FIG. 5A illustrates a state of temporary halt. During the temporary halt, a volatile component evaporates from an ejection orifice portion, and concentration of the ink proceeds in the vicinity of the ejection orifice. FIG. 5B illustrates a state immediately after a circulatory flow is generated by the second energy generating element afterward. The circulatory flow eliminates the concentration in the vicinity of the ejection orifice. The ink concentrated in the vicinity of the ejection orifice is discharged from the outlet port, and the concentration is eliminated in the entire separate flow path. FIG. 5C illustrates a state of another temporary halt afterward. Concentration of the ink proceeds again in the vicinity of the ejection orifice as with FIG. 5A. From there, a state immediately after another circulatory flow is generated by the second energy generating element is illustrated in FIG. 5D. The concentration in the vicinity of the ejection orifice is eliminated again, and the concentration is also eliminated in the entire separate flow path as with FIG. 5B. As described above, in the straight type in which the inlet port and the outlet port of the separate flow path is separated, each time temporary halt and such a circulating operation are repeated, the concentrated state is reset.

On the other hand, in FIGS. 6A to 6D, FIG. 6A illustrates the state of temporary halt. During the temporary halt, concentration of the ink proceeds in the vicinity of the ejection orifice as with FIG. 5A. FIG. 6B illustrates the state immediately after a circulatory flow is generated by the second energy generating element afterward. Here, by arranging the inlet port and the outlet port of the separate flow path adjacent to each other, the ink concentrated in the vicinity of the ejection orifice is discharged from the outlet port but flows in again from the inlet port. Thus, the entire separate flow path is replaced with the slightly concentrated ink instead of the fresh ink (hereinafter, referred to as recirculatory concentration). FIG. 6C illustrates the state of another temporary halt afterward. In such a case, further from the state of FIG. 6B, the concentration of the ink proceeds in the vicinity of the ejection orifice again as FIG. 6A illustrates. From there, the state immediately after another circulatory flow is generated by the second energy generating element is illustrated in FIG. 6D. In such a case, as FIG. 6B illustrates, under the effect of the recirculatory concentration, the replacement with the concentrated ink in the entire separate flow path further proceeds from FIG. 6B. As described above, in the U-shape type in which the inlet port and the outlet port of the separate flow path are adjacent, the concentrated state is not reset at the times when the temporary halt and the circulating operation are repeated, and the concentration gradually proceeds in the entire separate flow path, thereby exacerbating the concentrated state. Here, further, even if the circulating operation is not repeated, the concentrated state is hardly improved even in the first circulating operation, when the concentration becomes great in the vicinity of the ejection orifice due to, for example, long halt time. This is because the improvement of the concentrated state is small due to the recirculatory concentration.

Thus, between the straight type in which the inlet port and the outlet port of the separate flow path are separated and the U-shape type in which the inlet port and the outlet port of the separate flow path are adjacent, a difference in the state of concentration elimination with the temporary halt and the circulating operation exists due to a difference in the effect of the discharged concentrated ink. In the straight type, the concentrated state is easily eliminated, including the entire separate flow path, thereby hardly causing ejection stability reduction arising from the concentrated ink. In the U-shape type, on the other hand, the concentrated state is hardly eliminated, including the entire separate flow path, due to the recirculatory concentration, and ejection is thus likely to be unstable according to the concentration of the entire separate flow path.

### Ink

As described so far, the effect of the concentrated ink thickened by evaporating at the ejection orifice can be suppressed by generating an ink circulatory flow inside the separate flow path by using the second energy generating element although the degree of concentration elimination varies based on the difference in the flow path configuration. That is, since the ejection state of the ink can be maintained well, the effect of, for example, change in ejection speed can further be reduced, and stable ejection is easily achieved.

On the other hand, depending on the application of the liquid ejection head and the liquid ejection device in which the head is mounted, inks varying in color material type and in the content of a solid content are assumed to be used. That is, the ability to maintain high level of ejection stability no matter what ink is used can be the performance of the liquid ejection head. For example, for issues that may arise from the water in the ink, such as curling (warpage) and cockling (waving wrinkles) in plain paper, the use of an ink reduced in the amount of water is considered. Since the ink having a small amount of water has high concentration of an organic solvent and solid contents such as pigment and resin other than water, the viscosity is likely to increase sharply with water evaporation, which is likely to reduce the ejection stability of the ink. For such an ink, the method, as in the present invention, in which a circulatory flow is generated inside the pressure chamber is very effective because the viscosity of the ink can be suppressed from increasing. An ink having a large amount of a solid content usually indicates a solid content of 10 wt %. That is, the present invention can be applied to the ink whose content of the solid content in the ink is 10 wt % (mass %) or more.

Regarding the temperature in operating the head, there may be a case using the ink at a predetermined temperature achieved through heating by disposing and controlling heaters in the entire chip. Since the ink viscosity varies depending on the temperature, the ink viscosity at the head operating temperature affects the ejection stability.

When a circulatory flow is formed by the second energy generating element, a value of the circulatory flow velocity can be several tens of mm/s to 1000 mm/s in terms of instantaneous flow velocity. In an average flow velocity when observed in time range of the order of several hundreds of microseconds, the value of the circulatory flow velocity depends on the drive frequency of the circulatory heater. This is because, in the case of the circulatory heater, the circulatory flow is a transitional flow that attenuates over time and stops after a predetermined time period. When driving is performed at about 10 kHz to 20 kHz similar to the drive frequency (ejection frequency) of the first energy generating element, the average flow velocity of several mm/s to 100 mm/s can be achieved.

When using an ink having high pigment concentration, that is, for example, an ink having concentration with which the viscosity at the head operating temperature is 3 cP or more and 6 cP or less, thickening of the ink is likely to proceed at the ejection orifice portion according to non-ejection time (halt time). Thus, the ejection speed is likely to change, which is likely to reduce the ejection stability. Thus, the ink circulation needs to be performed while the halt time is still short, and the concentration needs to be eliminated by performing steady ink circulation or transitional ink circulation with high frequency. When the circulatory heater serves as the second energy generating element, the transitional ink circulation is formed, and performing the circulating operation with high frequency can thereby contribute to the concentration elimination at the ejection orifice portion.

On the other hand, when using an ink having low pigment concentration, that is, for example, an ink having concentration with which the viscosity at the head operating temperature is 1 cP or more and 2 cP or less, the ejection speed may change depending on the non-ejection time (halt time), but the effect thereof is relatively small compared with the ink of high concentration. On the other hand, when the halt time is long, for example, according to non-printing drive time (halt time), thickening of the ink proceeds at the ejection orifice portion. Thus, when restarting after the device has been stopped without printing for a predetermined time period, it is required to perform recovery processes involving waste ink such as a suction operation, a wiping operation, and preliminary ejection combined with the suction operation and the wiping operation. When the circulatory heater serves as the second energy generating element, forming a circulatory flow as the recovery operation can contribute to the concentration elimination at the ejection orifice portion without generating waste ink. Depending on the halt time, it is also possible not to generate waste ink by the recovery process only with the circulating operation. Another recovery process for minimizing waste ink can be achieved by, while performing the circulating operation for recovery, partially combining, for example, a suction operation for removing a bubble inside the head, which is different from the suction operation for concentration elimination.

In both the cases of the ink of high concentration and the ink of low concentration, returning to the initial fresh ink as much as possible can be performed to suppress the effect of the concentrated ink. Thus, even when the circulatory heater serves as the second energy generating element, the lower the effect of the recirculatory concentration, the better the circulation effect can be obtained. That is, the configuration of the straight type is more effective than the configuration of the U-shape type.

### First Embodiment

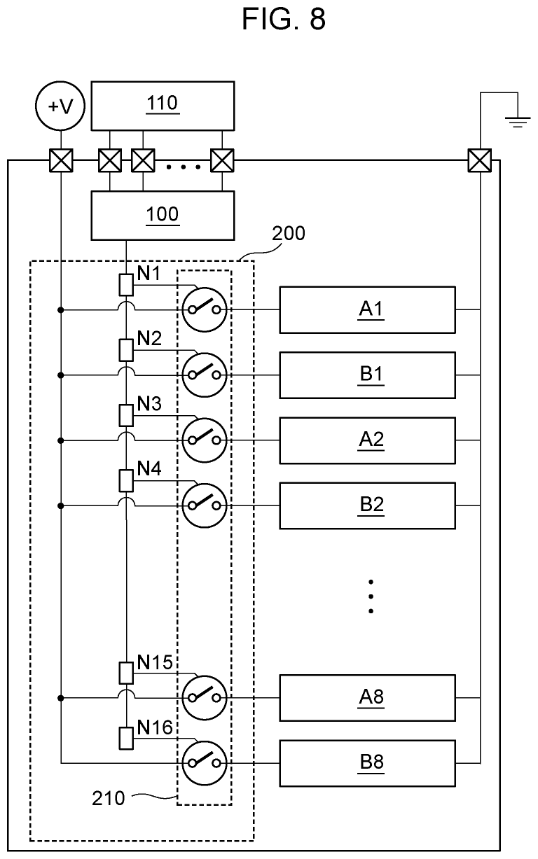

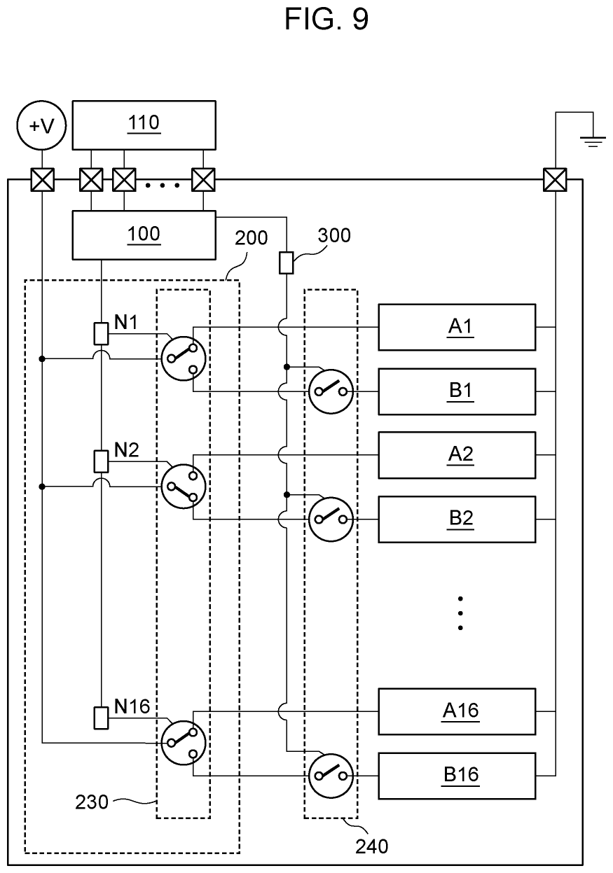

FIGS. 7A to 7C are each a schematic view illustrating, in detail, the vicinity of the ejection orifice of the liquid ejection head that ejects a liquid such as an ink in the first embodiment. FIG. 7A is a plan view when viewed from the side to which a droplet is ejected from the ejection orifice. FIG. 7B is a sectional view taken along line VIIB-VIIB in FIG. 7A. FIG. 7C is a schematic enlarged view illustrating element names in the separate flow path portion in FIG. 7A. In addition, FIG. 8 is a block diagram illustrating a selective driving circuit configuration on a substrate in a comparative configuration, and FIG. 9 is a block diagram illustrating a selective driving circuit configuration on the substrate in the present embodiment.

In FIGS. 7A and 7B, the ejection orifices 11 through which a liquid is ejected are formed in the orifice plate 19. The first energy generating element 14 is formed immediately below the ejection orifice 11 in the substrate 18. The second energy generating element 24, along with the first energy generating element 14, is formed in the substrate 18 in a similar manner to form the circulatory flow 27 in the separate flow path 23. The separate flow path 23 including the ejection orifice 11 is supplied with a liquid from the supply groove 42. At this point, both ends of the separate flow path are adjacent in the first direction that is the direction where the ejection orifices are arranged.

Here, in the system referred to as the U-shape type because of the shape of the flow path illustrated in FIG. 7A, both the ends of the separate flow path are adjacent in the first direction that is the direction where the ejection orifices are arranged. The name of each element also used in FIGS. 8 and 9 will be described. As FIG. 7C illustrates, in each of the separate flow paths 23, the first energy generating element 14 and the second energy generating element 24 are provided. To distinguish the elements from one another, each first energy generating element is referred to as Ai (i=1, 2, 3, . . . , n), and each second energy generating element is referred to as Bi (i=1, 2, 3, . . . , n). At this point, for example, A1 and B1 are given as the ones disposed inside the same separate flow path.

### Driving Method in Comparative Configuration

In the comparative configuration, a selective driving circuit 200 as illustrated in FIG. 8 is formed on a substrate 18. A voltage source (+V) and a controller 110 are provided outside the substrate and are connected to the selective driving circuit 200 on the substrate. There is included an ON-OFF driving circuit (an ON-OFF switch) 210 that drives, by turning on or off, the first energy generating element (A1 to A8) or the second energy generating element (B1 to B8) in response to a control signal at each address (in this configuration, N1 to N16) received from a control data supply circuit 100. That is, each of the first and second energy generating elements is independently controlled by the switch capable of switching between a drivable state in which the energy generating element can be driven and a driving disabled state in which the energy generating element cannot be driven. Here, the control data supply circuit controls a driving pulse for driving the first energy generating element or the second energy generating element and the time interval of application of the driving pulse to each element.

In the comparative configuration, the first energy generating element and the second energy generating element are linked with different addresses, and the driving circuits also need to be provided separately. Thus, the first energy generating element and the second energy generating element need to be provided with respective driving data. Accordingly, the amount of data is increased according to the combined total element number of the first energy generating elements and the second energy generating elements.

### Driving Method in Embodiment: Toggle Driving

In the present embodiment, a selective driving circuit 200 as illustrated in FIG. 9 is formed on the substrate 18. A voltage source and a controller 110 are provided outside the substrate and are connected to the selective driving circuit 200 on the substrate. There is included an ON-ON driving circuit (a first switch that performs ON-ON switching) 230 that drives, by turning on, any one of the first energy generating element (A1 to A16) and the second energy generating element (B1 to B16) in response to a control signal at each address (in the present embodiment, N1 to N16) received from a control data supply circuit 100. That is, there is provided the switch capable of switching the first energy generating element and the second energy generating element mutually exclusively so as to bring only any of the energy generating elements into the drivable state. With the switch, when the first energy generating element is in the drivable state, the second energy generating element is always in the driving disabled state, and, on the other hand, when the second energy generating element is in the drivable state, the first energy generating element is always in the driving disabled state. Here, the control data supply circuit 100 controls a driving pulse for driving the first energy generating element or the second energy generating element and the time (interval) of application of the driving pulse to each element.

Even when the second energy generating element side is selected in the ON-ON driving circuit 230, driving is controlled by an ON-OFF driving circuit (a second switch that performs ON-OFF switching) 240 for the second energy generating element, in response to further a drive propriety signal 300 of the second energy generating element. That is, the second energy generating element is further controlled by the switch capable of switching between the drivable state and the driving disabled state. Thus, when the first energy generating element is in the driving disabled state, the second energy generating element is in the drivable state but is actually driven only upon receiving a driving signal (drive propriety signal) that instructs drive relative to the second energy generating element. Without the drive propriety signal, the second energy generating element is not driven even when the second energy generating element side is selected in the ON-ON driving circuit 230. That is, at this time, neither the first energy generating element nor the second energy generating element is driven.

Summarizing the above, in the present embodiment, the driving circuit configured to control the drive of the first energy generating element and the second energy generating element includes: the first switch capable of switching the first energy generating element and the second energy generating element mutually exclusively so as to bring only any of the energy generating elements into the drivable state; and the second switch capable of switching, in the second energy generating element, between the drivable state and the driving disabled state, and the first energy generating element and the second energy generating element are controlled to be driven with the driving circuit under a condition below.

Condition: when the first energy generating element is driven, the second energy generating element is not driven, and, when the first energy generating element is not driven, the second energy generating element is driven upon receiving the driving signal that instructs drive relative to the second energy generating element.

Further, the ON-OFF driving circuit (the second switch) can be provided closer to the second energy generating element than the ON-ON driving circuit (the first switch), that is, relative to the second energy generating element, on the electrically downstream side. In addition, the plural second energy generating elements can be controlled to be driven by using the driving signal that is common thereto.

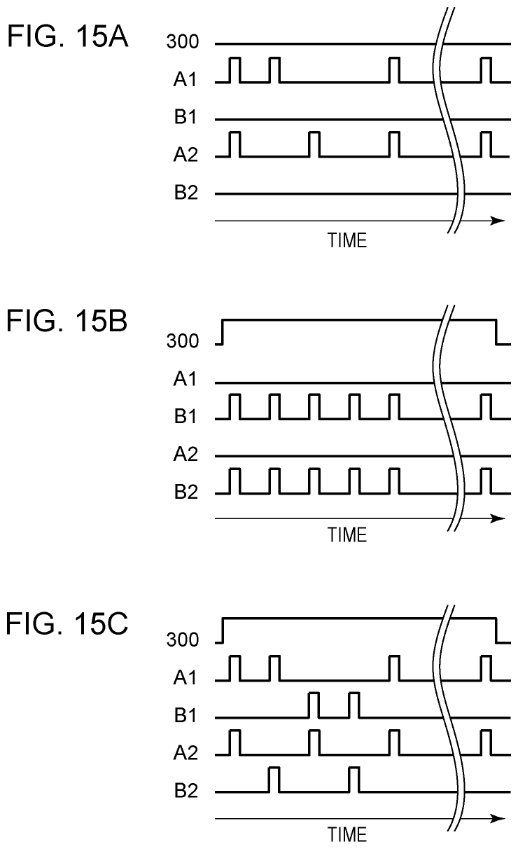

FIGS. 15A to 15C each illustrate the timing of drive to each energy generating element, relative to the circuit for each energy generating element illustrated in FIG. 9. The case of two sets of the first energy generating element and the second energy generating element is illustrated for brevity, but the same applies to cases of plural sets. In the case where no common drive propriety signal 300 is received as illustrated in FIG. 15A, only the first energy generating elements are selected and driven, and the second energy generating elements are not selected and not driven. On the other hand, in the case where the common drive propriety signal 300 is received as illustrated in FIGS. 15B and 15C, the second energy generating elements are selected and driven when the first energy generating elements are not selected. At this time, the first energy generating element and the second energy generating element inside the same separate flow path are driven mutually exclusively. By providing the common drive propriety signal 300 as described above, the driving timing when the second energy generating element is driven arises, and a circulatory flow is formed accordingly. By providing the common drive propriety signal 300 periodically, a circulatory flow is periodically formed accordingly, and it is thereby possible to obtain the continuous circulation effect.

In FIG. 15B, the first energy generating element is not selected, and, at that time, the second energy generating element is selected and driven. The case where none of the first energy generating elements is driven as described above corresponds to, for example, a case where the common drive propriety signal 300 is provided between scans or between pages in the printing operation. FIG. 15C illustrates the case where the first energy generating elements are selected and driven as with FIG. 15A, but the second energy generating elements are selected and driven in response to the common drive propriety signal 300 when the respective first energy generating elements are not selected. The case where the first energy generating element is driven sporadically as described above corresponds to, for example, a case where the common drive propriety signal 300 is provided when a character or an image is printed such as during scanning or the like in the printing operation.

Although the driving pulse of the energy generating element is indicated by one pulse here, a driving pulse constituted by plural, two or more pulses may be utilized. In addition, the same driving pulse may be given to the first energy generating element and the second energy generating element, or different driving pulses may be used.

Here, as a comparison, countermeasures for the thickened ink in a liquid ejection head in which no circulatory flow is formed will be described below. Examples of the countermeasures include a preliminary ejecting operation to eject the ink from an ejection orifice and a suction operation to suck the ink from the ejection orifice. For example, in a liquid ejection device of the serial type, the preliminary ejecting operation and/or the suction operation is performed before the head moves away from a cap provided for protecting the head at a head standby spot to proceed to a printing operation. Alternatively, the preliminary ejecting operation is performed in a non-print region out of a print medium when the carriage reciprocates to perform the printing operation. Such operations are performed at different timing from that of the printing operation. Further, in a case of an ink easily thickened, while added to the printing operation, the preliminary ejecting operation is sometimes performed onto the printing medium in a print region during the reciprocating so as not to affect an image.

In the present embodiment, the number of times of the preliminary ejecting operation and the suction operation can be reduced by performing the circulating operation by driving the second energy generating element. In that case, similarly, the circulating operation at the head standby spot or in the non-print region during the reciprocating is performed at different timing from that of the printing operation. Thus, in the present embodiment, with the drive propriety signal 300 of the second energy generating elements, the drive of the second energy generating elements can be easily controlled. Further, in the case of the ink easily thickened, in the circulating operation in the print region of the reciprocating, the ejection operation needs to be given priority in the timing close to that of the printing operation. On the other hand, there is no need to drive the circulating operation and the printing operation simultaneously, by providing plural timings or a predetermined time period for the circulating operation. Thus, in the present embodiment, the circulating operation can be controlled appropriately without exerting any effect on the printing operation by driving the first energy generating element when the first energy generating element side is selected.

As described so far, the second energy generating element is controlled to be driven according to the driving data of the first energy generating element and the drive propriety signal. Thus, since there is no need to provide driving data for the second energy generating element, there is an advantage of being able to reduce the amount of the driving data accordingly.

Even when plural second energy generating elements are provided, the plural second energy generating elements can be controlled to be driven based on the common drive propriety signal. Note that, although, in the present embodiment, the first energy generating elements Ai and the second energy generating elements Bi in the case of n=16 are controlled in one group of, in total, 32 elements (16 sets), the total element number per one group can be various numbers such as 16 (8 sets) and 24 (12 sets).

Although, in the present embodiment, the drive propriety signal 300 is described as being provided for the substrate 18 and controlling the drive of the second energy generating element, the drive propriety signal 300 may be provided for the liquid ejection head outside the substrate or the liquid ejection device outside the liquid ejection head to control the drive of the second energy generating element.

### Second Embodiment

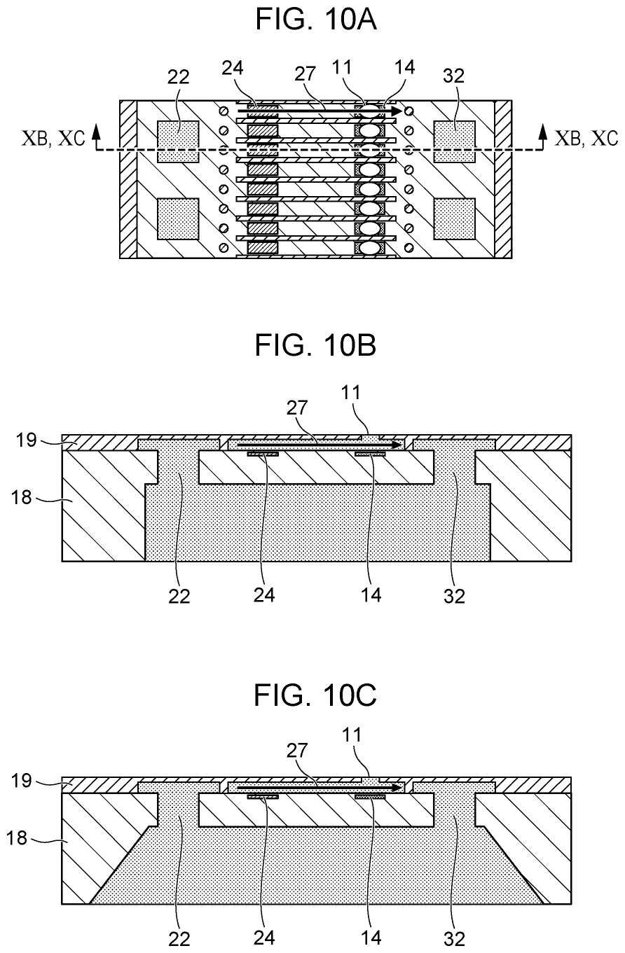

FIGS. 10A to 10C are each a schematic view illustrating, in detail, the vicinity of an ejection orifice of a liquid ejection head that ejects a liquid such as an ink in a second embodiment. FIG. 10A is a plan view when viewed from the side to which a droplet is ejected from the ejection orifice. FIGS. 10B and 10C illustrate two examples of sectional views taken along line XB-XB, XC-XC in FIG. 10A.

Although FIGS. 10B and 10C illustrate the two examples because the shape of the rear side of a substrate varies depending on the type of etching method for the substrate, a section may be of any of such shapes.

The present embodiment differs from the first embodiment in that the configuration of the present embodiment is of the straight type in which an inlet port and an outlet port of a separate flow path are separated. In the present embodiment, both ends of the separate flow path are disposed separately on opposite sides relative to a second direction orthogonal to a first direction where the ejection orifices are arranged.

An advantage of employing this configuration is that the effect of concentration is suppressed because, due to such separation of the inflow and the outflow of a circulatory flow in the opposite directions, the ink concentrated at an ejection orifice portion does not flow back into the separate flow path with the circulation.

### Third Embodiment

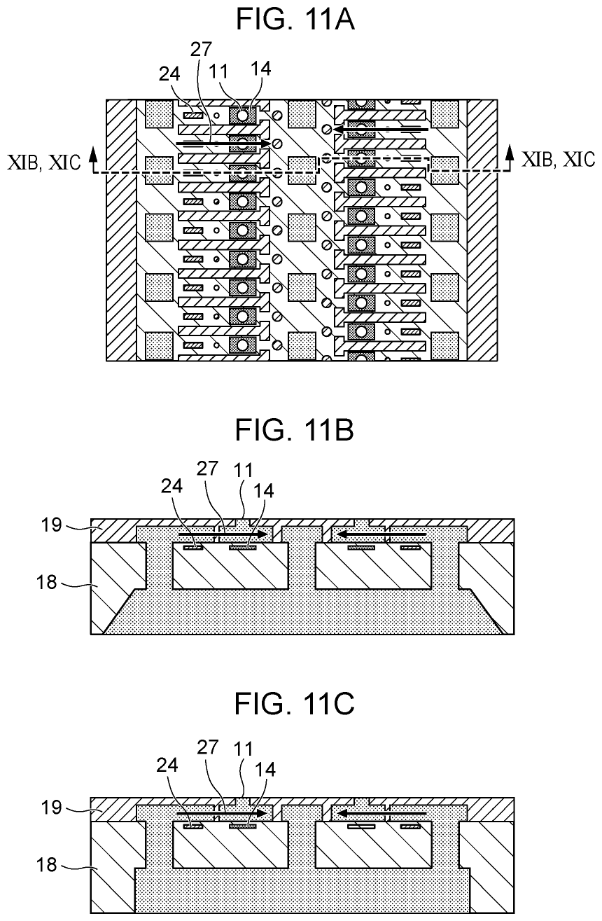

FIGS. 11A to 10C are each a schematic view illustrating, in detail, the vicinity of an ejection orifice of a liquid ejection head that ejects a liquid such as an ink in a third embodiment. FIG. 11A is a plan view when viewed from the side to which a droplet is ejected from the ejection orifice. FIGS. 11B and 11C illustrate two examples of sectional views taken along line XIB-XIB, XIC-XIC in FIG. 11A, as with FIGS. 10B and 10C.

The present embodiment differs from the second embodiment in that an ejection orifice array is doubled by providing three supply opening arrays, and each of the ejection orifice arrays is disposed on the side close to a central supply opening array. That is, the ejection orifice arrays are formed on both sides relative to an array direction of plural supply openings.

An advantage of employing this configuration is doubling of the ejection orifice array from one array to two arrays by increasing the number of the arrays of the supply openings from two to three by adding one array. As in the figure, arrangement in which the pitches of the two ejection orifice arrays are shifted from each other is also possible. In addition, a configuration that does not require a wiring area between the openings of the central supply opening array is possible, thereby achieving high flexibility in the size of the openings in the central supply opening array and the resolution. Thus, an advantage is facilitation of approach to high productivity by refilling a nozzle faster.

Note that the three supply opening arrays are at the same position in an inter-nozzle array direction in the present embodiment but may each be shifted according to the nozzle position and the wiring routing between the openings. The same applies to subsequent embodiments.

### Fourth Embodiment

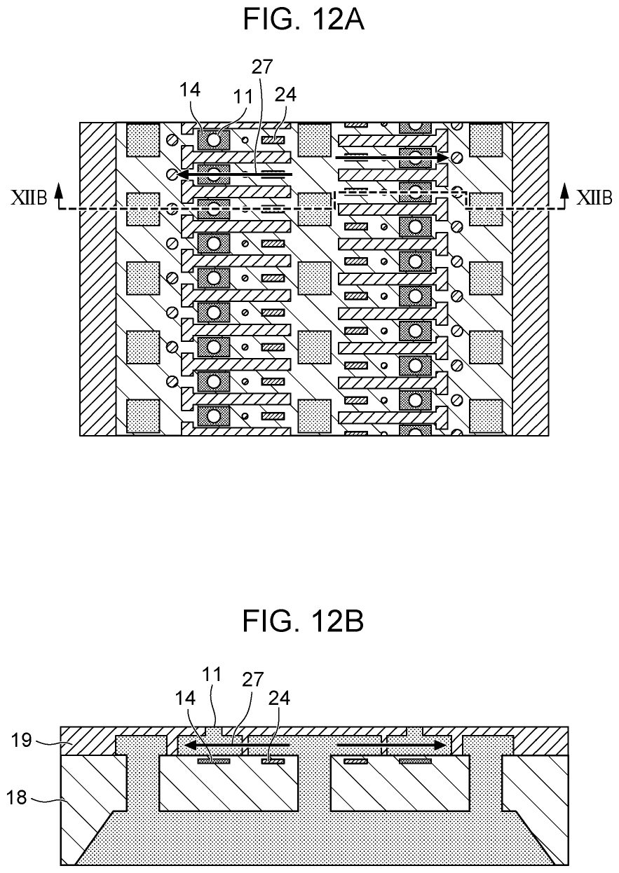

FIGS. 12A and 12B are each a schematic view illustrating, in detail, the vicinity of an ejection orifice of a liquid ejection head that ejects a liquid such as an ink in a fourth embodiment. FIG. 12A is a plan view when viewed from the side to which a droplet is ejected from the ejection orifice. FIG. 12B is a sectional view taken along line XIIB-XIIB in FIG. 12A.

The present embodiment differs from the third embodiment in that the direction of a circulatory flow is reversed by disposing ejection orifice arrays on the side close to respective supply opening arrays on both sides and disposing the second energy generating elements on the side close to a central supply opening array.

An advantage of employing this configuration is that the effect of the concentrated ink when flowing back into a separate flow path with ejection and the like is suppressed because the ink concentrated in the vicinities of the ejection orifices is discharged, while divided, into the supply opening arrays on both sides. In addition, an advantage is that the effect of interference caused by meniscus vibration with the ejection from each ejection orifice is suppressed because the ejection orifice arrays are disposed apart from each other.

### Fifth Embodiment

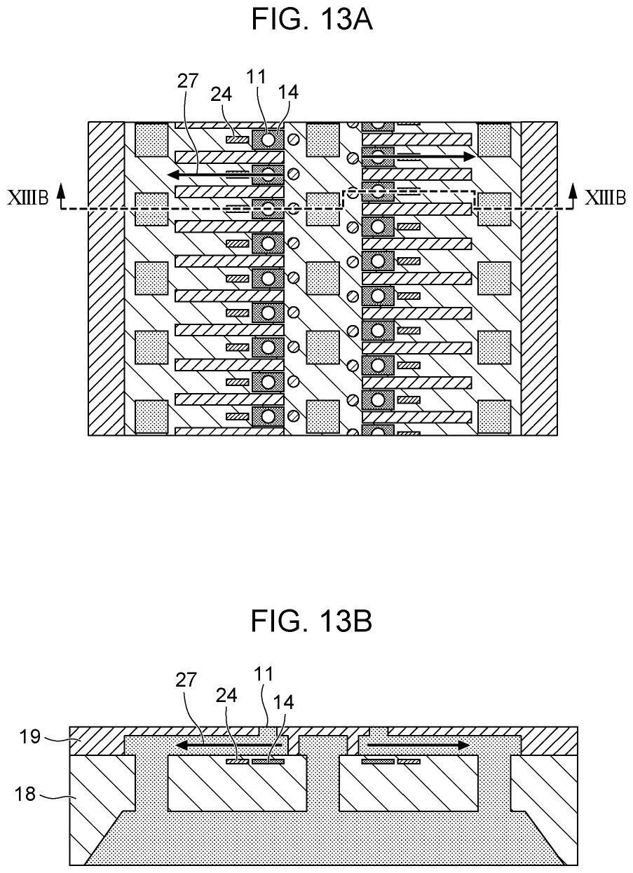

FIGS. 13A and 13B are each a schematic view illustrating, in detail, the vicinity of an ejection orifice of a liquid ejection head that ejects a liquid such as an ink in a fifth embodiment. FIG. 13A is a plan view when viewed from the side to which a droplet is ejected from the ejection orifice. FIG. 13B is a sectional view taken along line XIIIB-XIIIB in FIG. 13A.

The present embodiment differs from the third embodiment in that the direction of a circulatory flow is reversed by disposing second energy generating elements close to first energy generating elements and by disposing the second energy generating elements closer to a central supply opening array than to supply openings on both sides.

An advantage of employing this configuration is that approach to high productivity is facilitated by refilling faster due to high flexibility in the size of the central supply opening array and the resolution as with the third embodiment, and a further advantage is that the effect of the concentrated ink when flowing back into a separate flow path with ejection and the like is suppressed because the ink concentrated in the vicinities of the ejection orifices is discharged, while divided, into supply opening arrays on both sides.

### Sixth Embodiment

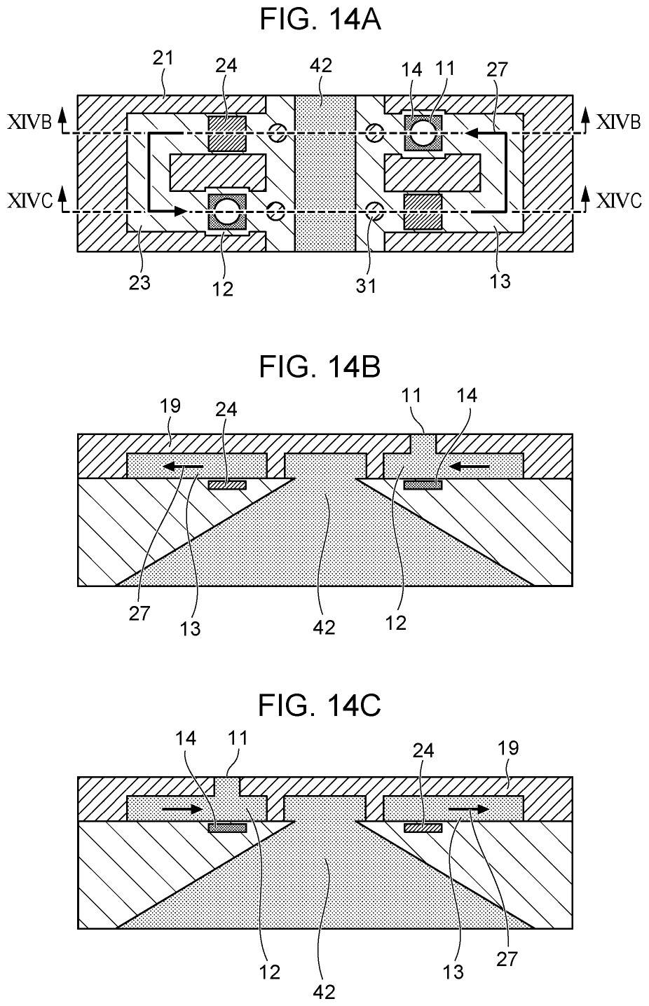

FIGS. 14A to 14C are each a schematic view illustrating, in detail, the vicinity of an ejection orifice of a liquid ejection head that ejects a liquid such as an ink in a sixth embodiment. FIG. 14A is a plan view when viewed from the side to which a droplet is ejected from the ejection orifice. FIGS. 14B and 14C are sectional views taken along lines XIVB-XIVB and XIVC-XIVC in FIG. 14A, respectively.

The present embodiment differs from the first embodiment in that a staggered arrangement is employed for ejection orifice arrays on the left and the right across a supply groove and that a filter is provided also at an inlet port of a separate flow path (in the vicinity of a second energy generating element). Even in such configurations, the effects of the present invention can be obtained in a similar manner.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-040044, filed Mar. 14, 2024 and Japanese Patent Application No. 2024-226777 filed Dec. 23, 2024, which are hereby incorporated by reference herein in their entirety.

What is claimed is:

1. A liquid ejection method using:
a separate ejection unit including
an ejection orifice through which a liquid is ejected,
a pressure chamber communicating with the ejection orifice,
a first heat energy generating element provided for the pressure chamber and configured to generate heat energy for ejecting a liquid from the ejection orifice,
a separate flow path communicating with the pressure chamber, and
a second heat energy generating element provided for the separate flow path; and
a liquid ejection head including a common flow path for supplying a liquid to a plurality of the separate flow paths of a plurality of the separate ejection units, wherein
the first heat energy generating element and the second heat energy generating element are controlled to be driven under a condition that,
when the first heat energy generating element is driven, the second heat energy generating element is not driven, and,
when the first heat energy generating element is not driven, the second heat energy generating element is driven upon receiving a driving signal that instructs drive relative to the second heat energy generating element.

2. The liquid ejection method according to claim 1, wherein
the liquid ejection head includes a drive control unit configured to control drive of the first heat energy generating element and the second heat energy generating element of the separate ejection unit.

3. The liquid ejection method according to claim 1, wherein
a plurality of the ejection orifices in the plurality of the separate ejection units forms an ejection orifice array.

4. The liquid ejection method according to claim 1, wherein
the plurality of the separate flow paths of the plurality of the separate ejection units and the common flow path are connected through an opening.

5. The liquid ejection method according to claim 3, wherein,
in the separate flow path of the separate ejection unit, the first heat energy generating element and the second heat energy generating element are disposed in a direction intersecting the ejection orifice array.

6. The liquid ejection method according to claim 5, wherein
the separate flow path extends in the direction intersecting the ejection orifice array such that both end portions of the separate flow path are positioned across the ejection orifice array.

7. The liquid ejection method according to claim 6, wherein
one ends of the plurality of the separate flow paths and the common flow path are connected through a plurality of first openings arranged along the ejection orifice array, and the other ends of the plurality of the separate flow paths and the common flow path are connected through a plurality of second openings arranged along the ejection orifice array.

8. The liquid ejection method according to claim 7, wherein
a first ejection orifice array and a second ejection orifice array are formed on both sides relative to an array direction of the plurality of second openings.

9. The liquid ejection method according to claim 8, wherein,
in the plurality of the separate flow paths, a plurality of the first heat energy generating elements is disposed on a side close to the plurality of second openings.

10. The liquid ejection method according to claim 8, wherein,
in the plurality of the separate flow paths, a plurality of the second heat energy generating elements is disposed on a side close to the plurality of second openings.

11. The liquid ejection method according to claim 3, wherein,
in at least one separate flow path of the plurality of the separate flow paths, the first heat energy generating element and the second heat energy generating element are disposed along the ejection orifice array.

12. The liquid ejection method according to claim 11, wherein
both end portions of the separate flow path are positioned on one side relative to the ejection orifice array.

13. The liquid ejection method according to claim 1, wherein
a plurality of the second heat energy generating elements is controlled to be driven by using the driving signal that is common.

14. A liquid ejection head comprising:
an ejection orifice through which a liquid is ejected;
a pressure chamber communicating with the ejection orifice;
a first heat energy generating element provided for the pressure chamber and configured to generate heat energy for ejecting a liquid from the ejection orifice;
a separate flow path communicating with the pressure chamber;
a second heat energy generating element provided for the separate flow path; and
a driving circuit configured to control drive of the first heat energy generating element and the second heat energy generating element, wherein
the driving circuit includes
a first switch capable of switching the first heat energy generating element and the second heat energy generating element mutually exclusively so as to bring only any of the first heat energy generating element and the second heat energy generating element into a drivable state, and
a second switch capable of switching, in the second heat energy generating element, between the drivable state and a driving disabled state.

15. The liquid ejection head according to claim 14, wherein,
in the driving circuit, the second switch is provided closer to the second heat energy generating element than the first switch.
